(19) United States
(12) Patent Application Publication
(10) Pub. No.: US 2010/0332264 A1
(43) Pub. Date: Dec. 30, 2010

(54) SYSTEM AND METHOD FOR ADMINISTERING DEFERRED TERM LIFE INSURANCE ASSOCIATED WITH A SAVINGS PLAN

(75) Inventors: Keith E. Golembiewski, Suffield, CT (US); Philip W. Michalowski, Glastonbury, CT (US); David P. Wiland, South Windsor, CT (US)

Correspondence Address: Howard IP Law Group, P.O. Box 226, Fort Washington, PA, 19034, US

(73) Assignee: Hartford Fire Insurance Company, Hartford, CT (US)

(21) Appl. No.: 12/505,155

(22) Filed: Jul. 17, 2009

Related U.S. Application Data
(60) Provisional application No. 61/219,894, filed on Jun. 24, 2009.

(51) Int. Cl. G06Q 40/00

(52) U.S. Cl. 705/4

(57) ABSTRACT

A computer system for administering a plan for providing life insurance associated with a savings plan to attain a target balance at a target date, the system having a processor and a memory in communication with the processor. The processor is adapted to, responsive to receiving data including a death of the insured, determine whether the death occurred after a deferral period and before the target date. The processor is further adapted to, responsive to determining that the death occurred after the deferral period and before the target date, determine a death benefit amount based on the date of death, the death benefit amount being less than the target balance; and provide an output signal indicative of the amount of the death benefit to be paid to the savings plan.

### RELATED APPLICATIONS

This application claims the benefit of U.S. Provisional Patent Application Ser. No. 61/219,894, filed Jun. 24, 2009, the entire disclosure of which is incorporated by reference herein.

### FIELD OF INVENTION

The present invention relates to computer systems, and particularly to computer systems for calculating features of financial products.

### BACKGROUND

In life insurance policies, a death benefit is conventionally payable from the issue of the policy until either termination, such as until the expiration of a predefined term as in term life insurance policies, or until a date of early termination for nonpayment of premium. In term life policies, a unit cost of insurance is ordinarily determined based on the risk of death of an insured from the period commencing with the inception of coverage, usually upon receipt of premium.

In financial planning for large expenses, such as a college education, a family wage earner may make periodic payments, such as annually to a fund. Depending on the type of expense involved, the fund may be in an account that qualifies for preferential tax treatment. The family may plan that the wage earner makes payments to the fund until the fund reaches a desired target balance. If the wage earner dies before making the last payment, the fund will not reach the desired balance.

### SUMMARY

In one embodiment, a computer system for administering a plan for providing term life insurance associated with an education savings program has a processor and a memory storage device in communication with the processor. The processor is adapted to: receive and store data related to a term life insurance and savings program, including a date of establishment of a savings account, a target balance of the savings account at a target date at least 10 years after the establishment of the savings account; a death benefit under a term insurance policy amount applicable to a death of the insured occurring after a deferral period of at least about three years and before the target date; the benefit amount being less than the target balance at all times and decreasing over a period from expiration of the deferral period to the target date. The processor is further adapted to, responsive to receiving data including a death of the insured, determine whether the death occurred during the deferral period and before the target date. The processor is further adapted to, responsive to determining that the death occurred after the deferral period and before the target date, determine a benefit amount based on the date of death; and to provide an output signal indicative of the death benefit amount and instructions to make a payment to the savings account equal to the death benefit amount.

In an embodiment, a computer system for administering a plan for providing life insurance associated with a savings plan to attain at least a first target balance at a first target date for a first expenditure includes a processor and a memory storage device in communication with the processor. The processor is adapted to: receive and store data related to the plan, the data including: savings account data; an amount of the first target balance at the first target date at least 10 years after the establishment of the savings account; and a term life insurance death benefit amount pursuant to a term life insurance policy issued at a time of commencement of the savings program and applicable to a death of the insured occurring after a deferral period of at least about three years; the death benefit amount for a date before the first target date being less than the first target balance and decreasing between an expiration of the deferral period and the first target date. The processor is further, responsive to receiving data including a death of the insured, adapted to determine whether the death occurred during the deferral period and before the first target date. The processor is further adapted to: responsive to determining that the death occurred after the deferral period and before the first target date, determine a death benefit amount based on the date of death; and provide an output signal indicative of an amount of payment, equal to the death benefit amount, to be made to the savings program.

In an embodiment, a computer-implemented method for administering a plan for providing life insurance associated with a savings plan to attain at least a first target balance at a first target date for a first expenditure, includes: receiving by a processor, and storing by the processor in a memory device in communication with the processor, data related to the plan, the data including: savings account information including a date of establishment of the savings account; an amount of the first target balance at the first target date at least 10 years after the establishment of the savings account; and a term life insurance death benefit amount pursuant to a term life insurance policy issued at a time of commencement of the savings plan and applicable to a death of the insured occurring after a deferral period of at least about three years; the death benefit amount for a date before the first target date being less than the first target balance and decreasing between an expiration of the deferral period and the first target date. The method further includes: responsive to receiving by the processor data including a death of the insured, determining by the processor whether the death occurred during the deferral period and before the first target date; responsive to the determining by the processor that the death occurred after the deferral period and before the first target date, determining by the processor a benefit amount based on the date of death; and providing by the processor an output signal indicative of an amount of payment, equal to the death benefit amount, to be made to the savings account.

In an embodiment, a computer-readable medium having a plurality of instructions thereon which, when executed by a processor, cause the processor to: receive and store data related to a term life insurance and savings program, the data including: savings account information, and a date of establishment of the savings program; an amount of a target balance at a target date at least 10 years after the establishment of the savings program; and a term life insurance death benefit amount pursuant to a term life insurance policy issued at a time of commencement of the savings program and applicable to a death of the insured occurring after a deferral period of at least about three years; the death benefit amount for a date before the target date being less than the target balance and decreasing between an expiration of the deferral period and the first target date. The instructions further cause the processor to, responsive to receiving data including a death of the insured, determining whether the death occurred during the deferral period and before the target date; responsive to determining that the death occurred after the deferral period and before the target date, determining a benefit amount based on the date of death; and provide an output signal indicative of an amount of payment to be made to the savings program, the amount being equal to the death benefit amount.

In an embodiment, a computer system for determining terms of a long term savings program with deferred term life insurance includes a processor and a memory device in communication with the processor. The processor is adapted to: receive from a client device data including an age of a proposed insured, a nature of a proposed expense, data indicative of a date or range of dates at least 10 years in the future of the proposed expense, and data indicative of an amount of the proposed expense; based on the received data, determine a plan including dates and amounts of periodic contributions to the savings program; death benefit amounts for the deferred term life insurance; a deferral period of at least three years for the deferred term life insurance, and premiums for the deferred term life insurance; and provide to the client device an output signal having data indicative of the plan; wherein the premiums are determined based on a unit cost of insurance determined based on a first discount factor based on the length of the deferral period, the probability of the insured surviving until the expiration of the deferral period, and the sum of the probabilities of death of the insured during each year following the expiration of the deferral period until the date of the last contribution, the probabilities of the death during each of the years being discounted by a discount factor specific to each of the years.

In an embodiment, a computer-implemented method for determining terms of a long term savings program with deferred term life insurance, includes: receiving by a processor from a client device data including an age of a proposed insured, a nature of a proposed expense, data indicative of a date or range of dates at least 10 years in the future of the proposed expense, and data indicative of an amount of the proposed expense; based on the received data, determining by the processor a plan including dates and amounts of contributions, which may be periodic contributions over a period of at least 10 years to the savings program; death benefit amounts for the deferred term life insurance; a deferral period of at least three years for the deferred term life insurance, and a level premium for the deferred term life insurance; and providing to the client device an output signal having data indicative of the plan; wherein the level premium is determined based on a unit cost of insurance determined based on a first discount factor based on the length of the deferral period, the probability of the proposed insured surviving until the expiration of the deferral period, and the sum of the probabilities of death of the proposed insured during each year following the expiration of the deferral period until the date of the last contribution, the probabilities of the death during each of the years being discounted by a discount factor specific to each of the years.

In an embodiment, a computer-readable medium has a plurality of instructions thereon which, when executed by a processor, cause the processor to: receive from a client device data including an age of a proposed insured, a nature of a proposed expense, data indicative of a date or range of dates at least 10 years in the future of the proposed expense, and data indicative of an amount of the proposed expense; based on the received data, determine a plan including dates and amounts of periodic contributions over a period of at least 10 years to the savings program; death benefit amounts for the deferred term life insurance; a deferral period of at least three years for the deferred term life insurance, and a level premium for the deferred term life insurance; and provide to the client device an output signal having data indicative of the plan; wherein the level premium is determined based on a unit cost of insurance determined based on a first discount factor based on the length of the deferral period, the probability of the insured surviving until the expiration of the deferral period, and the sum of the probabilities of death of the insured during each year following the expiration of the deferral period until the date of the last contribution, the probabilities of the death during each of the years being discounted by a discount factor specific to each of the years.

### BRIEF DESCRIPTION OF THE FIGURES

FIG. 1 is a schematic diagram of an exemplary computer system for implementation of a method and system of the invention.

FIG. 2 is a schematic diagram of an exemplary network for implementation of a method and system of the invention.

FIG. 3 is an illustration of an embodiment of a method and system for providing a savings program with deferred term life insurance.

FIG. 4 is a table illustrating particular dollar values in the embodiment of FIG. 3.

FIG. 5 is an illustration of an embodiment of a method and system for providing a savings program with deferred term life insurance, similar to FIG. 3, in which the death benefit is paid.

FIG. 6 is a table illustrating particular dollar values in the embodiment of FIG. 5.

FIG. 7 is a process flow diagram of a process for administration of a savings program with deferred term life insurance.

FIG. 8 is a process flow diagram of a process for determination of parameters of a savings program with deferred term life insurance.

FIG. 9 is a schematic diagram of a computer system according to an embodiment and a payment determination system.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for administration of insurance policies and investment products such as qualified college savings plans and retirement plans. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

A challenge recognized by the inventors in connection with savings for life events, such as a college education or wedding for a child, is that the purchase of term life insurance to provide for replacement of contributions to a fund by a wage earner may involve unnecessary expense. For example, a fixed death benefit over a twenty year term, calculated to be sufficient to replace funding if the insured dies near the middle of the term, would result in an unnecessarily large death benefit being paid if the wage earner died after making all but the last year or two of contributions to the fund. Such an unnecessarily large death benefit results in unnecessarily large premium expenses.

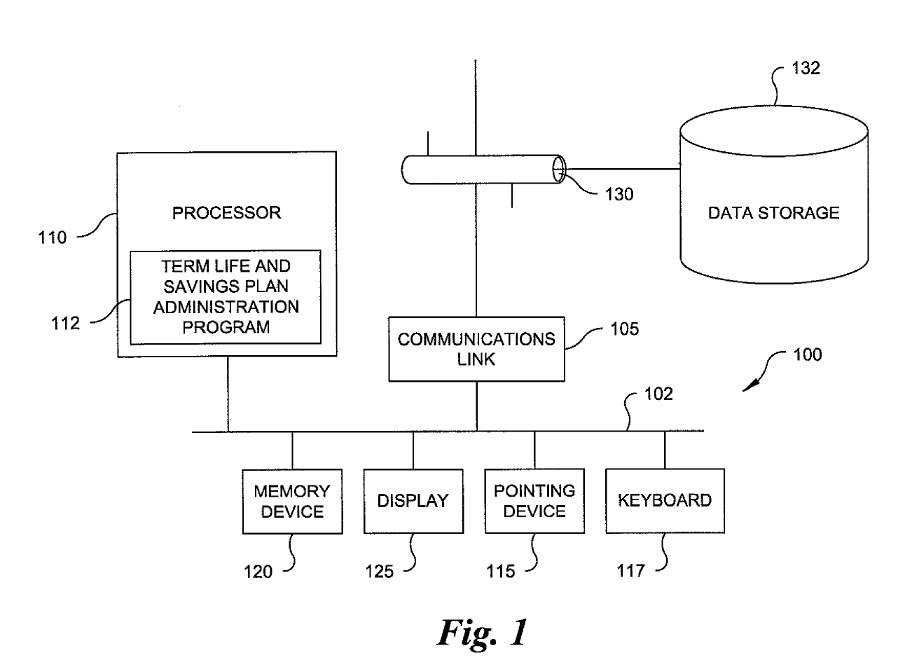

Referring to FIG. 1, an exemplary computer system 100 for use in an implementation of the invention will now be described. In computer system 100, processor 110 executes instructions contained in programs such as term life and savings plan administration program 112. Programs may be stored on suitable media, such as optical or magnetic disks, fixed disks with magnetic storage (hard drives), tapes accessed by tape drives, and other storage media. Processor 110 communicates, such as through bus 102 and/or other data channels, with communications link 105 and memory device 120, receives data from user inputs such as pointing device 115 and keyboard 117, and provides data to outputs, such as data to video drivers for formatting on display 125. Memory device 120 is configured to exchange data with processor 110, and may store programs containing processor-executable instructions, and values of variables for use by such programs. In an embodiment, inputs may include user interfaces, including workstations having keyboards, touch screens, pointing devices such as mice, or other user input devices, connected via networked communications to processor 110. Outputs may include displays and printers. Communications link 105 may communicate with remote sources of information, and with systems for implementing instructions output by processor 110, via LAN 130. LAN 130 is merely exemplary, and communication may be by one or more of suitable communication methods, including over wired or wireless local area networks and wide area networks, and over communications between networks, including over the Internet. Any suitable data and communication protocols may be employed. Data storage 132, which may include a wide variety of data acquired and processed in accordance with embodiments, is accessed via LAN 130. Data storage 132 may include data concerning individual insureds, savings plans and term life policies, by way of example.

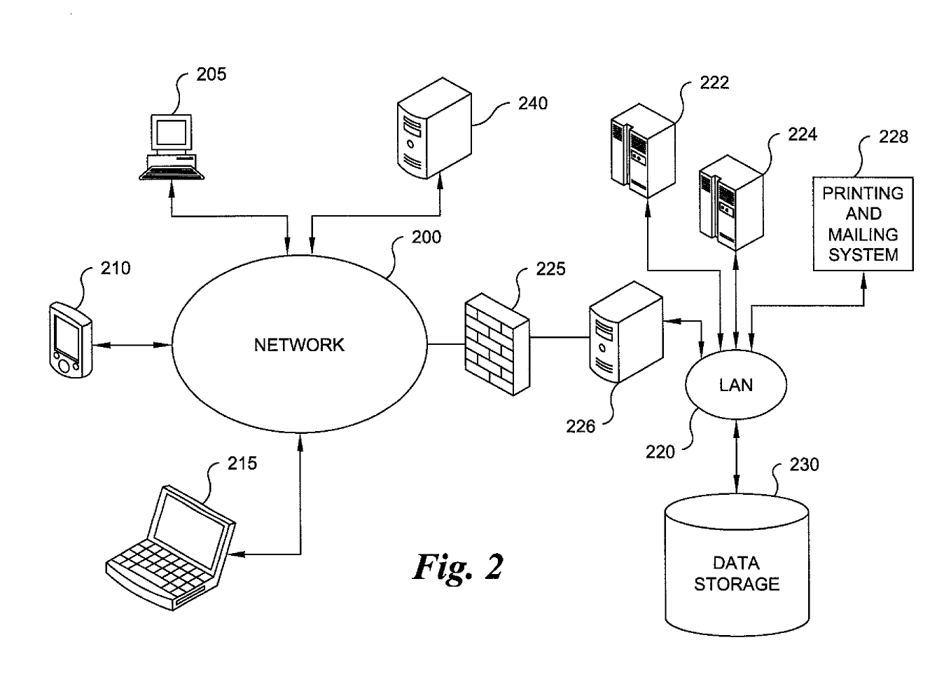

Referring now to FIG. 2, a schematic diagram of a network arrangement including a client server arrangement for implementation of a method and system in accordance with an embodiment of the invention is presented. In the arrangement of FIG. 2, client devices 205, 210, 215 may be connected via network 200 to server 226. In an implementation, client devices 205, 210, 215 may be personal computers running an operating system such as Windows XP, Windows Vista, or Apple Tiger, thin client devices, portable devices such as personal digital assistants (running the Palm OS, by way of example), cell phones, or other devices. Client devices may be operated variously by individual prospective insureds, insurance brokers or other financial advisors, or by personnel of an insurance or financial services provider. Network 200 may be or include the Internet, a corporate intranet, wireless and wired communications channels, and other network features. Firewall 225 may be configured to provide data security services with respect to systems and networks, including exemplary server 226 and LAN 220. Firewall 225 may include distinct hardware, including a processor and memory device, to provide virus protection and user authentications services, for example. In an embodiment, the devices protected by firewall 225 may be systems of an insurance carrier. Server 226 may have a processor that is configured or configurable to receive data, such as requests for illustrations of savings plans with deferred term life insurance for particular life events. Server 226 may receive requests to generate deferred term life insurance policy documents, and may pass those requests, such as via LAN 220, to another computer system, such as mainframe system 222, which may be based on the IBM/360 platform. Mainframe system 222 may in response to a request and suitable data generate policy documents, which may then be passed in electronic format via LAN 220 to printing and mailing system 228. Printing and mailing system 228 may print and mail documents provided by mainframe system 222, or print and mail illustrations furnished by server 226, among other examples. Server 226 may run various programs that serve to initiate and monitor sessions with one more of client devices 205, 206, 207. Server 226 may serve for display on client devices 205, 210, 215, prompts to the user for information relevant to anticipated funding needs, such as dates of birth and gender of children in connection with savings for education and to fund weddings, anticipated retirement dates, and other data.

A program running on server 226, or on another computer system linked to server 226 via LAN 220, may include instructions causing the computer system's processor to determine features, such as premiums, of a deferred term life insurance policy to replace contributions to a 529 account or other account designated for a particular future need. Server 226 may format and serve to client devices 205, 210, 215 illustrations of such insurance accounts, which may be based on illustration data generated by server 226 or by another computer system in communication with server 226 via LAN 220. Programs, such as program 112 of FIG. 1, may include instructions causing server 226 to display on a client device 205, 210, 215 prompts to permit a user to input data in association with an illustration, such as on the same screen as an illustration, via a link on the screen displaying the illustration to one or more pages permitting a user to change the data. For example, the user may change underlying assumptions regarding anticipated costs of education, weddings, or other events. In response to receipt of the changed data, a program stored on a storage device of a computer system may cause a processor to determine, cause a processor of server 226, to serve to the appropriate one of the client devices 205, 210, 215 an updated illustration.

Server 226 may implement instructions in programs that provide a web front end, linked to back end computer systems for implementing administration of deferred term life insurance policies. For example, mainframe 224 may include programs for administration of issued insurance policies. Data storage 230 may include data relating to address, payment preferences and other data associated with administration of policies and savings account. Data storage 230 may include a database having savings program data, including current and historical savings plan or savings program balance data. Server 226 may, by way of example, provide a user with options to update contact information and payment information, such as bank account and routing number for electronic payments of premiums and/or benefits, and be configured to receive signals from user device 205, 210, 215 inputting such information, and to communicate such information to back end systems such as mainframe 224 and data storage 230 via LAN 220. Server 226 may in response to a request from a client device, access and serve for display on the client device data relating to the plan, including a current balance of the savings account, the target balances, dates and amounts of planned future contributions, and current death benefit amount.

Server 226 may also access third party systems, such as server 240. Server 240 may be a system of a third party financial institution that is administering an account of the savings program, while server 226 administers a term life insurance policy of the program. Server 226 may access server 240 to obtain account data, such as current balance information for the savings account, for example, and to confirm receipt of planned contributions.

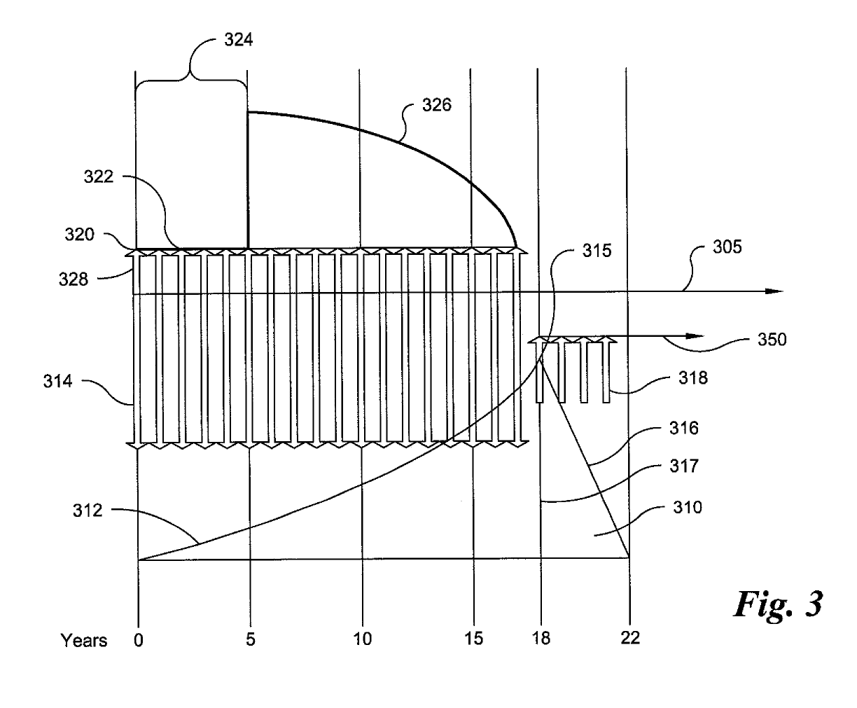

Referring now to FIG. 3, an exemplary embodiment of a method and system according to the invention will be discussed. Insured and contributor 305 is to make contributions 314 at a series of dates, in certain amounts, over a period of years, to a savings fund 310. Savings fund 310 may be a savings account. A savings account may be a single account or multiple accounts. Savings accounts may include qualified college savings accounts and qualified retirement savings accounts, as well as non-qualified accounts. A processor has received and stored in a memory device the series of dates and the amounts of the planned future contributions by insured 305 to the savings fund 310. The dates of the planned future contributions are at least annually over a period of at least 10 years. The dates of the planned future contributions may be more frequent, such as quarterly, or monthly; the dates may be based on dates of anticipated payroll payments to insured 305, for example. The amounts of contributions 314 may be level, or may change over time. For example, the amount of each contribution may be planned to increase from a first level to a second, higher level, one or more times over the plan. The amount of contributions 314 may also be determined for all or a portion of the term of payments according to a formula depending on a balance in savings fund 310.

Contributions 314 are shown to be planned annually for a period of 18 years to savings fund 310. The first contribution may occur substantially immediately, such as on the day of inception of the savings program, or within a brief period, such as 10 days thereafter. This example is suitable for funding of a college education for a child commencing around the time of the child's birth; however, the particular number of contributions is merely exemplary. The balance of savings fund 310 increases at 312 as a result of contributions and earnings on the contributed funds. A target balance 315 is reached at target date 317. In this example, target date 317 is year 18 of the savings program, which corresponds to age 18 of the child. Target date 317 is at least about 10 years after inception of the savings plan and issuing of a term life insurance policy, as discussed below. The expenditure in this example is in the nature of educational expenses. Payments 318 are made to educational institution 350, such as a college or university, over a period after the target date 317 while the child is attending college. Payments 318 result in a declining balance, shown at 316, in savings fund 310, until the fund is completely depleted at year 22. At that time, the child is expected to graduate from college and not have any further educational expenses to be provided by savings fund 310.

At the time of establishment of the savings plan, insured 305 has also entered into a term life insurance contract with a policy issuer. A processor has received and stored in a memory device data relating to the term life insurance contract. The policy is shown generally at 320. The data include a deferral period 324, of at least about three years after issue of the policy, during which deferral period the death benefit is zero, as shown at 322. In embodiments, a deferral period may be at least five years. In the example of FIG. 3, the deferral period 324 is five years. Premiums 328 are paid at regular intervals, such as annually or a shorter period, from the inception of the policy until the termination of the policy. The premiums are paid during deferral period 324. Premiums 328 may be level, or may vary during the term of the policy.

In an embodiment, insured 305 may provide periodic payments to a provider, such as an insurance company, for funding of both the contributions 314 and the premiums 328. The provider will deposit an appropriate portion of the received payment in the account corresponding to savings fund 310, and credit an appropriate portion as a payment of premium. In an embodiment, payments may be made by preauthorized electronic funds transfer from an account, such as a checking account, of the insured, by payroll deduction, or in another manner.

The data also include a death benefit amount applicable to a death of the insured occurring after the deferral period. The benefit amount is at all times not greater than the target balance. The death benefit amount decreases at dates further in the future after the deferral period an approaching the target date. The death benefit is shown at 326 declining after the deferral period 324 until the planned date of the last contribution. The death benefit amount may be fixed for each time period. For example, the death benefit may be equal to the target balance at inception. The death benefit may decrease on the planned date of each planned contribution by the amount of each planned contribution. A table may be stored in memory by a processor mapping dates of death to death benefit amounts. The initial death benefit amount may be fixed at a present value of the target balance, based on an assumed interest rate. The initial death benefit amount may be determined based on a present value of the target balance, based on a formula in which an interest rate is determined according to an external source at the end of the deferral period.

The death benefit amount may be determined by a formula, based on the difference between the target balance and the balance of savings fund 310 at a date related to the date of death of the insured, such as the date of death, the date of payment, an average balance in a period prior to the death, by way of example.

In an embodiment, if the insured fails to provide any contributions at the time and in the amount determined and stored in memory, the term life insurance policy 320 may be terminated. The insured may have a grace period for payments. Payment of the death benefit may be contingent on payment of each of the planned contributions at the time and in the amount determined. If at the time of death, a grace period for making of a payment or completion of a payment has not yet expired, then a death benefit may still be paid. Thus a processor may access data indicative of whether a grace period is applicable.

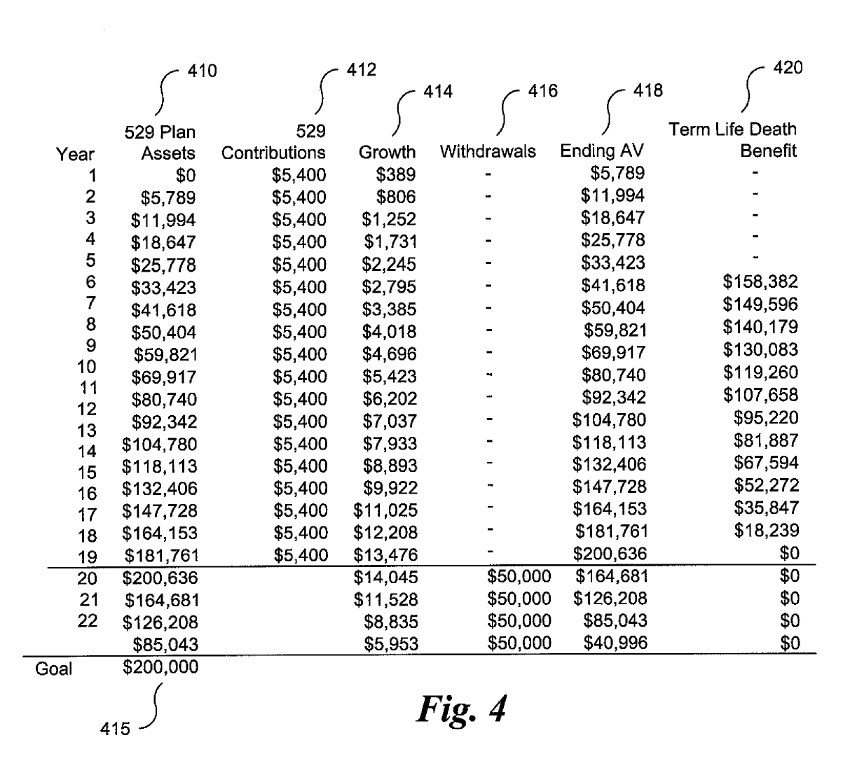

Referring now to FIG. 4, an exemplary illustration is shown, consistent with FIG. 3, with particular dollar amounts. In this example, the target balance is $200,000, to be achieved at the target date, on the eighteenth anniversary of the account, i.e., at the commencement of year 19 of the account. The annual contributions to the savings plan, which is a tax free 529 plan, is $5400. The assumed net returns are 7.2% per annum. The contributions and the anticipated earnings on the contributions are sufficient to attain the target balance by the target date. The projected balance at the target date is slightly higher than the target balance. The savings plan assets at the beginning of each year are shown in column 410. The savings plan assets at the end of year are shown in column 418. Until withdrawals commence, savings plan assets at the end of each year are the sum of the assets at the beginning of the year, contributions shown in column 412 and returns on investments shown in column 414. When withdrawals, shown in column 416 commence, savings plan assets are reduced by the withdrawals, and continue to increase by earnings on the funds in the account. The final account balance does not reach zero in this illustration, as the assumed withdrawals in the total amount of $200,000 are spread over four annual payments, and are partially offset by earnings. The deferral period is five years. The life insurance death benefit amount is calculated each year by subtracting the projected year end asset value from column 418 from the goal 415. Upon death of the insured, the death benefit is paid into the savings account, thereby replacing the remaining contributions.

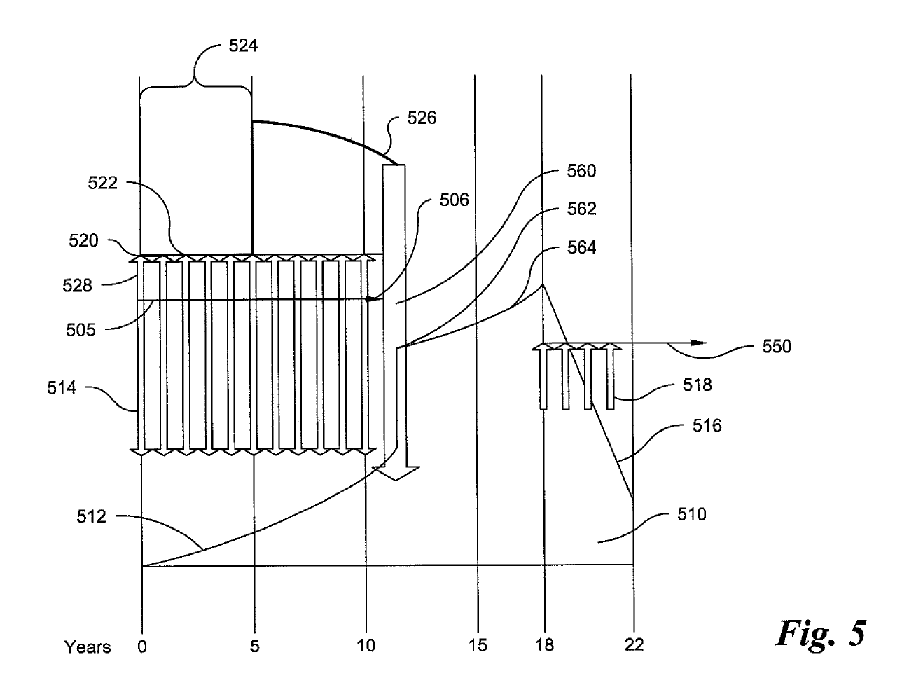

Referring now to FIG. 5, an embodiment of a method and system of FIG. 3 is illustrated including payment of a death benefit. In FIG. 5, insured and contributor 505 is to make contributions 514 at a series of dates, in certain amounts, over a period of years, to a savings fund 510. Contributions 514 are planned to be made annually for a period of 18 years to savings fund 510.

Insured 505 has also entered into a term life insurance contract 520 with a policy issuer. Five year deferral period 524 is indicated as having a death benefit of zero, as shown at 522. Premiums 528 are paid at regular intervals.

Contributions are made and premiums are paid through the deferral period and until year 11. The balance of savings fund 510 increases at 512 as a result of contributions and earnings on the contributed funds. The death benefit amount decreases as indicated at 526. As indicated at 506, insured 505 dies in year 11 of the plan. The policy makes a death benefit payment 506 to savings fund 510. The balance of the savings fund 510 increases to the target balance, as indicated at 562. The balance continues to increase as indicated at 564 as a result of earnings on the savings. At the target date, the balance is in excess of the target balance. Payments 518 are made to an educational institution 550, with the balance decreasing at 516 but remaining positive after all planned payments are made.

In an embodiment, responsive to receiving data including a death of the insured, a processor of a system for administering a savings plan with deferred life insurance may determine whether the death occurred during the deferral period and before the target date, and determine whether all other conditions are met, including that the planned contributions prior to the death had been made and that all premiums had been paid. Responsive to determining that the death occurred after the deferral period and before the target date, the processor may determine a benefit amount based on the date of death. The benefit amount may be based on amounts fixed at the time of issue of policy, or based on a formula in which an actual or expected balance of the savings account is a factor. The processor may provide an output signal indicative of an amount of payment to be made to the savings plan account.

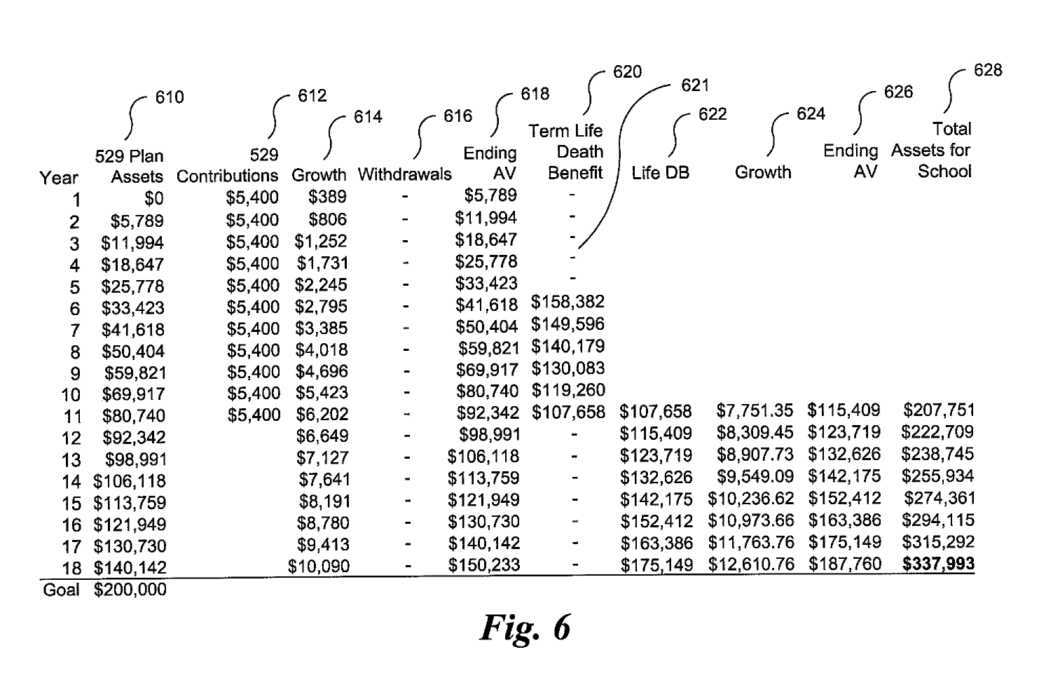

Referring now to FIG. 6, an exemplary illustration is shown, consistent with FIG. 5, with particular dollar amounts. The target balance is $200,000, and the annual contribution is planned to be $5400, shown in column 612, over 18 years. The term life insurance has a deferral period of five years, as indicated at 621, and a declining death benefit shown equal to the difference between the target amount and the projected account balance at the end of the year in which death occurs, as can be seen in column 620. The first eleven contributions are made to the savings plan. The savings plan balance, shown in the beginning of each year at 610 and at the end of each year in column 618, is shown to be continuing to increase with earnings on the funds, as shown in column 614. There are no withdrawals during the time period illustrated, as indicated by column 616. The death benefit of $107,658 is paid in year 11 of the plan. The savings amount attributable to the death benefit at the beginning of each year is shown in column 622. The investment earnings on the death benefit during each year is shown in column 624, and the value of the savings amount attributable to the death benefit at the end of each year is shown in column 626. Column 628 shows the sum of the savings attributable to the contributions and the death benefit, which is the total amount available for educational purposes. Advantageously, the funding goal is met, with a lower cost than would be obtained with term life insurance having an immediately payable death benefit that is level and high enough to match the death benefit payable under an embodiment immediately at the expiration of the deferral period. It will be appreciated that the target balance may be achieved with lower death benefit amounts.

Exemplary methods of determination of the cost of insurance will now be discussed. A unit cost of insurance may be determined by a processor to determine the cost paid only if the insured dies between the age of the insured at the expiration of a deferral period, and a second, greater age, at the end of the term. In an embodiment, the term may expire at the payment of the last planned contribution prior to the target date. In an embodiment, the term may expire at another date, such as the target date. The unit cost of insurance may be determined by summing over each year from the expiration of the deferral period to the end of the term the likelihood of the death of the insured, and applying a discount factor. The discount factor is specific to each year during that time period.

By way of example, the cost per unit of term insurance paying a death benefit if an individual now aged x dies between age x+m and age x+m+n may be expressed as:

$$m \vert A {x}^{t} \text{:} \overline{n} \vert = {v}^{m} {}_{m}^{}{p}{}_{x}^{} {\sum }_{k = m}^{n - 1} {v}^{k + 1} {}_{k}^{}{q}{}_{x + m}^{}$$

Here, the expression v^{m} is a discount factor equal to (1+i)^{-m}. The factor m is the deferral period. Accordingly, the discount factor, and hence the unit cost of insurance, decreases as the deferral period increases. The discount factor is based on the length of the deferral period. The expression mpx is the probability that a person currently aged x will survive to age x+m, and thus is the probability that the insured will survive until the expiration of the deferral period. The expression v^{k+1} is also a discount factor, reflecting an increased discount factor for years further from the present. The expression ₖqₓ₊ₘ is the probability that a person aged x+m will die in year k, and thus represents the probability of death of the insured for each year from the expiration of the deferral period until the end of the term, at year n. The discount factor is different for each year.

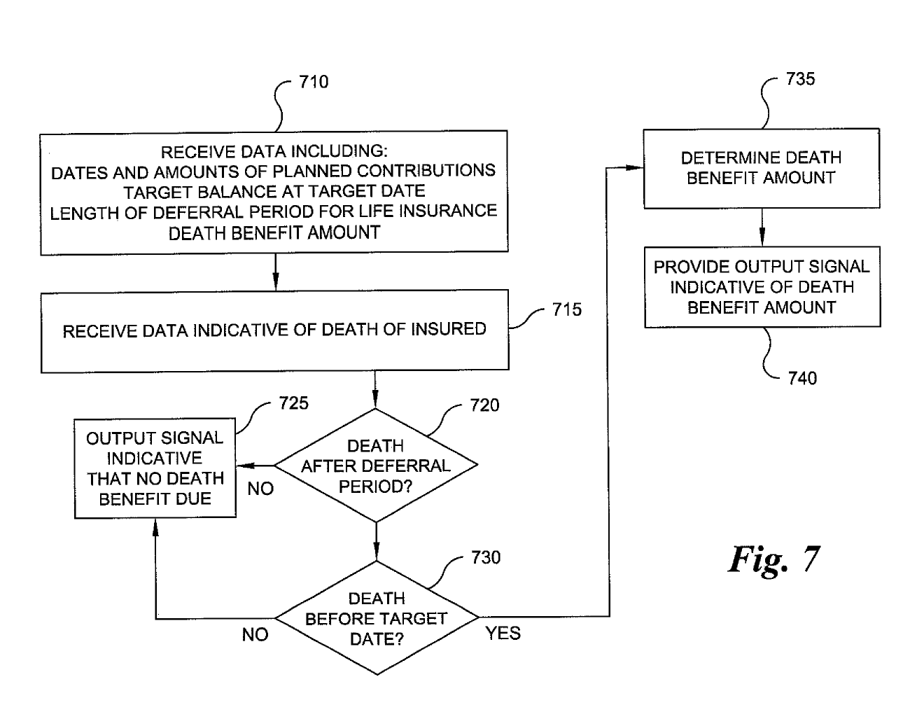

Referring to FIG. 7, a process flow of a process according to an embodiment will be explained. A processor may receive and store 710 data related to a term life insurance and savings program.

The data may include a series of dates and amounts of planned future contributions by an insured to the savings program, the dates of the planned future contributions being at least annually over a period of at least 10 years. The data may further include a target balance of the savings program at a target date at least 10 years in the future; a term life insurance benefit amount applicable to a death of the insured occurring after a deferral period of at least about three years. The benefit amount being less than the target balance and decreasing at dates further in the future.

The processor receives 715 data indicative of the death of the insured, and including a date of death. Responsive to receiving that data, the processor may determine 720 whether the death occurred after the expiration of the deferral period. If the processor determines that the death did not occur after the expiration of the deferral period, the process flow may end with an output signal that no death benefit is payable. If the processor determines that the death occurred after the expiration of the deferral period, the process flow may proceed to the processor determining 730 whether the death occurred prior to the target date. In another embodiment, the processor may determine whether all planned contributions to the savings fund were made timely and in the proper amount. In that embodiment, if the planned contributions were made timely and in the proper amounts, the processor may proceed to determine 735 the benefit amount. The determination of the benefit amount is dependent on the date of death. The determination may also be dependent on data regarding the savings account. By way of example, the processor may access data regarding the savings account via a network, such as a LAN, to determine balance data. The processor may output 740 a signal indicative of a benefit amount. The processor may also access information indicative of a beneficiary identity, and provide a signal indicative of the benefit amount and beneficiary identity to a payment determination system.

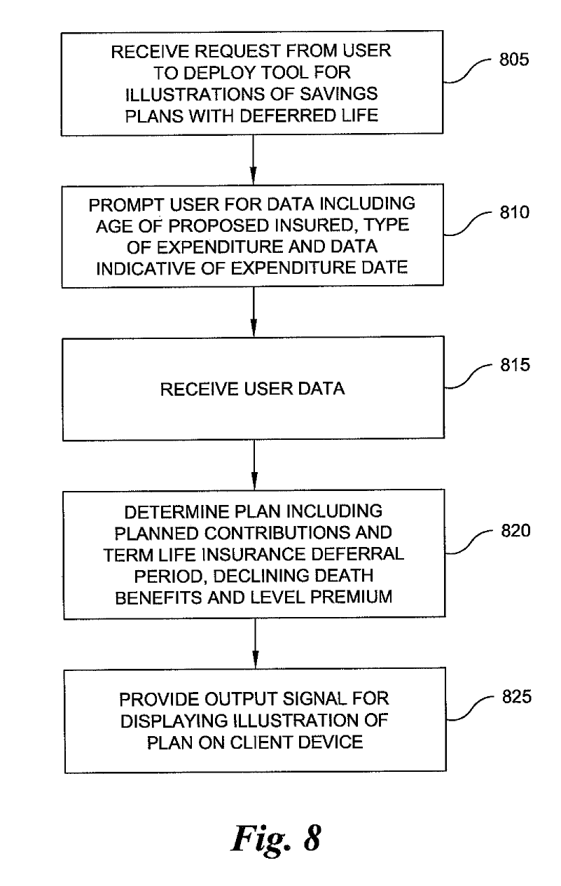

Referring now to FIG. 8, a process flow of a computer-implemented method for preparing an illustration of a plan including a savings plan and deferred term life insurance. A processor may receive 805 a request from a user employing a client device for a software tool to provide illustrations of plans. Referring to FIG. 2, a user may employ one of client devices 205, 210, 215 to provide a signal including a request via network 200 to server 226. Signals from client devices may be checked for viruses by firewall 225 before being passed to server 226. Firewall 225 may also perform user authentication to require user login prior to use of a tool, and then authenticate messages received from the client devices. Server 226 may provide responses via network 200 to client devices 205, 210, 215. Referring again to FIG. 8, in response to the request, the processor may 810 implement instructions from the software tool to prompt the user to provide data. The prompts may be in the form of a web form displayed on a page, or displayed sequentially on a series of pages in response to user completion of prior pages. The received data may include an age or birth date or birth year of a proposed insured, an age or birth date or birth year of the spouse of a proposed insured, number of children, ages, birthdates or birth years of children, current income, current income from wages or other income from current employment or business ownership (e.g., S-corporation profits), current savings amounts and amounts currently directed to savings on a periodic basis, an amount of additional funds that can be saved on a periodic basis, e.g. monthly; whether the user currently has a qualified savings plan, such as a qualified college savings plan, such as one or more 529 plans, 401(k) or other qualified retirement plans and balances of those plans and amounts currently contributed on regular basis to those plans; death benefit amounts and term of current term life insurance, or death benefit amounts and current cash values of permanent life insurance; nature of proposed expenses, such as college education for one or more children, including expense category of school, such as Ivy League, state university, lower-priced private college or university; wedding expenses for identified children and selected amount of wedding expenses; ownership of business and nature of business; major travel and range of expenses and type of travel. The user may be prompted to provide a proposed amount to set aside on a regular basis for one or more of the identified goals.

The processor may receive 815 the user data. After receiving the data, and based on the received data, the processor may determine 820 a plan including a target balance and a target date; an annual contribution to the savings plan, death benefit amounts or formula for the deferred term life insurance providing for declining death benefits after the expiration of the deferral period; a deferral period for the deferred term life insurance, and a level premium for the deferred term life insurance. The target balance may be based on, for example, a type of college selected, an amount input for a wedding fund, a type of travel or trip selected, or other data. The target date may be based on birthdates of children, e.g., at 18 years for the child for college fund, at a selected age or at a default age such as 28 years for a savings plan for a wedding. The amount of the annual contribution may be based on an amount sufficient to reach the target balance by the target date, using rate of return assumptions stored in memory, and including any existing balance included in the received data. The deferral period may be a default deferral period stored in memory. The death benefit amounts may be equal to the target balance less a predicted balance in the savings account. The processor may provide 825 an output signal indicative of the plan; the output signal may, for example, provide a display of an illustration, similar to the illustration shown in FIG. 4, for display on the client device. The level premium may be determined based on a unit cost of insurance determined based on a likelihood of the proposed insured surviving until the expiration of the deferral period, with that likelihood discounted, and a sum of the probabilities of the death of the proposed insured during each year of coverage, such as each year from the expiration of the deferral period through the date of the last contribution, including discounting for the time period until the death based on a discount factor applicable to each of those years. Data concerning probabilities of insureds or proposed insureds surviving until the expiration of the deferral period and dying during each year following the expiration of the deferral period until the date of the last contribution may be based on age of the proposed insured, age and gender of the proposed insured, and actuarial data, such as that available in suitable actuarial tables. Other factors, such as health-related factors, may also be received from the client device and employed in determining probabilities of survival and death in conjunction with actuarial data. Such health-related factors may include those known in the art and those developed hereafter. Suitable actuarial tables are well known to those of skill in the art.

In an alternative embodiment, payment of a death benefit may not be contingent on contributions being made. Payment of a death benefit may be contingent on premiums being paid, subject to applicable grace periods.

In an embodiment, the premium may not be set at the commencement of the plan. The premiums for the deferral period may be determined at the commencement of the plan and/or at the issue of the policy (which may be the same date). After the expiration of the deferral period, the premium for each time period, such as a year, may be set at a particular rate for each dollar of death benefit for that year, with the number of dollars being calculated at the beginning of the year or another selected date based on the difference between the savings account balance and the target balance. The rate per dollar of death benefit, or unit cost of insurance, may be set at the commencement of the plan, or may be adjusted or recalculated during the term.

In an embodiment, the premiums due for the term life insurance may be deducted from an account of a savings plan. In some types of plans, the deduction of the premium amount may not be feasible for regulatory reasons.

In an embodiment, the timing and dates of the contributions to the savings plan may not be determined at the commencement of the plan and stored in memory. In an embodiment, contributions may simply be received and added to the account balance.

In an embodiment, the term during which the death of the insured must occur for the death benefit to be payable may expire on the target date or the day prior to the target date.

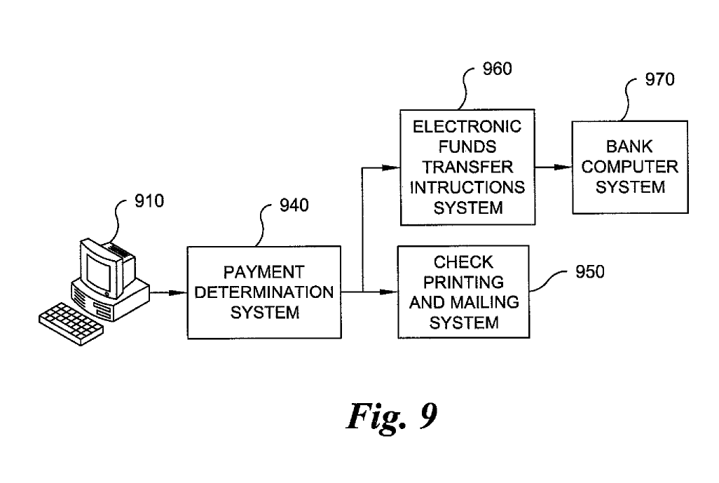

Referring to FIG. 9, in an embodiment, a system 910 for administration of a plan according to an embodiment may communicate with a payment determination system 940. Payment determination system 940 may include one or more computer systems, including processors, memory devices, user inputs, outputs, software executed by the processors, and other conventional components. Payment determination system 940 may be adapted to receive an output signal from computer system 910, such as via a LAN, which output signal includes data indicative of payment information, such as amounts payable to a 529 plan account for the benefit of a child, to a retirement account of a survivor, directly to a beneficiary, or to another designee, a date payable, and payment methods. Payment determination system 940 may further be adapted to determine a payor account and a payment method. The payor account may be an account with a selected bank; by way of example, payment determination system 940 may include a look-up table mapping beneficiary information, such as geographic information, to a particular bank and account. Payment determination system 940 may also include stored in memory and accessible by a processor information indicating whether a particular beneficiary is to be paid by paper check, by electronic funds transfer, or by another payment method. A processor of payment determination system 940 may cause to be stored in memory of the payment determination system the determined payor account information and the determined payment method. The processor of payment determination system 940 may cause a digital signal to be output indicative of the stored payor account information, the stored payment method, amount information and payee information. Depending on the payment method information, payment determination system 940 may direct a signal to one of a number of potential recipients. The potential recipients may include payment fulfillment systems, such as check printing and mailing system 950 and electronic funds transfer instructions system 960. The payment fulfillment systems may be for receiving the digital signal from the payment determination system 940 and for fulfillment of payment in accordance with the information conveyed by the digital signal from the processor of the payment determination system 940.

In an embodiment, the payment method may be by check; given that payment method, the output digital signal from payment determination system 940 may be received by check printing and mailing system 950. Check printing and mailing system 950 may include one or more computer systems, including processors, memory devices, user inputs, outputs, software executed by the processors, and other conventional components. The outputs include in particular one or more printers, and may include other devices useful in printing and mailing paper checks, such as devices for feeding paper, separating printed checks, inserting printed checks into envelopes, sealing envelopes, and applying postage to envelopes as appropriate. Check printing and mailing system 950 may print a check drawn on a payor account in an amount and to a payee as determined by the information conveyed by the digital signal from the processor of payment determination system 940. The printed check is then mailed to the payee. The payee deposits the check in the payee's bank account, causing funds to be credited to the payee's bank account, and causing the funds to be withdrawn from the designated payor bank account from which the payment is made.

In an embodiment, the output digital signal from payment determination system 940 may be received by electronic funds transfer instructions system 960. For example, this may be the case if the payment method is by electronic funds transfer to the payee's designated account. Electronic funds transfer instructions system 960 may include one or more computer systems, including processors, memory devices, user inputs, outputs, software executed by the processors, and other conventional components. Electronic funds transfer instructions system 960 includes a processor adapted to provide an output signal indicative of an instruction to a bank determined by the payor account information to provide an electronic funds transfer from the payor account to a payee account in an amount as previously determined. The amount is the amount determined by the information conveyed by the digital signal from payment determination system 940.

The output signal from electronic funds transfer instructions system 960 may be provided to a bank computer system 970, which carries out an electronic funds transfer, debiting the designated account, and resulting in a credit to a designated payee account.

In an embodiment, a savings program may have a first target balance at a first target date for a first expenditure, a second target balance at a second target date for a second expenditure, and continuing through further expenditures. For example, the saving plan may provide for savings for a period, such as 18 years, for educational expenses. The savings plan may provide for savings for a further period, such as 10 years, for wedding expenses. The savings plan may provide for further savings for 10 years for retirement savings. The term life policy may have a first death benefit that declines as the first target date approaches, and a second death benefit that is initially greater than the first death benefit. The death benefit may decline as the second target date approaches and savings for the second expenditure increase. The death benefit may increase again after the second target date and decrease as the third target date approaches. The death benefit amounts, lengths of time between target dates, target balances, number of target dates, and purposes for target dates, may vary. The plan may include multiple accounts, such as a qualified college savings account, a non-qualified account for saving for wedding expenses, and a qualified retirement savings account.

The present invention is operable with computer storage products or computer readable media that contain program code for causing a processor to perform the various computer-implemented operations. The computer-readable medium is any data storage device that can store data which can thereafter be read by a computer system such as a microprocessor. The media and program code may be those specially designed and constructed for the purposes of the present invention, or they may be of the kind well known to those of ordinary skill in the computer software arts. Examples of computer-readable media include, but are not limited to magnetic media such as hard disks, floppy disks, and magnetic tape; optical media such as CD-ROM disks; magneto-optical media; and specially configured hardware devices such as application-specific integrated circuits (ASICs), programmable logic devices (PLDs), and ROM and RAM devices. Examples of program code include both machine code, as produced, for example, by a compiler, or files containing higher-level code that may be executed using an interpreter. Steps in the computer-implemented methods may be implemented in processors running software stored locally, and/or in configurations such as application service providers, in which certain steps are executed on processors communicating with one another over a network such as the Internet. Either stand-alone computers or client/server systems, or any combination thereof, may be employed.

A system in accordance with the invention may include means corresponding to each step in each method described herein. Each means may be implemented by a processor executing instructions contained in programs which may be stored in a storage medium and loaded into random access memory for execution. It will be appreciated that any of the steps in the methods in accordance with the invention described herein may be so implemented.

An exemplary advantage of a system and method in accordance with an embodiment is that a unit cost of insurance may be reduced compared to term insurance having an immediately payable death benefit, as a result of the deferral period. A further exemplary advantage is that a premium may be reduced compared to term insurance having a level death benefit amount equal to a maximum death benefit amount in an embodiment, in view of the decreasing death benefit amounts as the target date approaches.

While the foregoing invention has been described with reference to the above embodiments, various modifications and changes can be made without departing from the spirit of the invention. Accordingly, all such modifications and changes are considered to be within the scope of the appended claims.

What is claimed is:

1. A computer system for administering a plan for providing term life insurance associated with an education savings program, comprising:
a processor;
a memory storage device in communication with the processor;
the processor adapted to:
receive and store data relating to the plan, including:
a date of establishment of the plan;
data identifying a savings account;
a target balance of the savings account at a target date at least 10 years after the establishment of the plan;
a death benefit under a term life insurance policy amount applicable to a death of an insured occurring after a deferral period of at least about three years and before the target date, the benefit amount being less than the target balance at all times and decreasing over a period from expiration of the deferral period to the target date;
responsive to receiving data including a death of the insured, determine whether the death occurred after the deferral period and before the target date;
responsive to determining that the death occurred after the deferral period and before the target date, determine a death benefit amount based on a date of death; and
provide an output signal indicative of the death benefit amount and instructions to make a payment to the savings account equal to the death benefit amount.

2. The system of claim 1, wherein the processor is further adapted to store in memory, at the establishment of the plan, dates and amounts of planned contributions to the savings account, and wherein the processor is further adapted to determine that the death benefit is payable only if each of the planned contributions has been made prior to the death of the insured.

3. The system of claim 1, wherein the processor is further adapted to store in memory, at the establishment of the plan, dates and amounts of planned contributions to the savings account, and the death benefit amount is equal to the difference between the target balance and a planned balance, the planned balance being based on the planned contributions and planned earnings on the planned contributions, of the savings account as of the date of death.

4. The system of claim 1, wherein the deferral period is at least five years, and the target date is at least 15 years from the establishment of the plan.

5. The system of claim 1, wherein the death benefit amount is equal to the present value of the difference between a balance of the savings account as of the time of death and the target balance.

6. The system of claim 1, wherein the savings account is a qualified college savings account.

7. A computer system for administering a plan for providing life insurance associated with a savings plan to attain at least a first target balance at a first target date for a first expenditure, comprising:
a processor; and
a memory storage device in communication with the processor;
the processor adapted to:
receive and store data related to the plan, the data including:
a date of inception of the plan;
savings account data;
an amount of the first target balance at the first target date at least 10 years after the inception of the plan; and
a term life insurance death benefit amount pursuant to a term life insurance policy issued at a time of inception of the plan and applicable to a death of the insured occurring after a deferral period of at least about three years, the death benefit amount for a date before the first target date being less than the first target balance and decreasing between an expiration of the deferral period and the first target date;
responsive to receiving data including a death of the insured, determine whether the death occurred after the deferral period and before the first target date;
responsive to determining that the death occurred after the deferral period and before the first target date, determine a death benefit amount based on the date of death; and
provide an output signal indicative of an amount of payment, equal to the death benefit amount, to be made to the savings account.

8. The system of claim 7, wherein the savings account comprises a qualified college savings account.

9. The system of claim 7, wherein the savings account comprises a qualified retirement savings account.

10. The system of claim 7, wherein the death benefit for a given date of death is fixed at the time of issue of the policy.

11. The system of claim 7, wherein the death benefit is the present value of the difference between a balance of the savings account and the first target balance as of the date of death of the insured.

12. The system of claim 7, wherein the processor is adapted to access a database having savings account data to obtain a balance of the savings account as of a selected date based on the date of death, and to determine the death benefit based on the obtained balance.

13. The system of claim 7, further comprising a web server, the web server adapted to, in response to a request from a client device, access and serve for display on the client device data relating to the plan, including a current balance of the savings account, the first target balance, dates and amounts of planned future contributions, and current death benefit amount.

14. The system of claim 7, wherein the received and stored data further comprises:
a second target balance at a second target date a period of years after the first target date for funding of a second expenditure, and
a second term life insurance death benefit amount pursuant to the policy; the second death benefit amount being for a date after the first target date and before the second target date, the second death benefit amount being less than the second target balance and decreasing between the first target date and the second target date;
wherein the processor is further adapted to, responsive to receiving data indicative of a death of the insured, determine if the date of death is after the first target date and before the second target date, and, responsive to determining that the date of death is after the first target date and before the second target date, determine a death benefit amount based on the date of death; and
provide an output signal indicative of an amount of payment, equal to the death benefit amount, to be made to the savings program.

15. A computer-implemented method for administering a plan for providing life insurance associated with a savings plan to attain at least a first target balance at a first target date for a first expenditure, comprising:
receiving by a processor, and storing by the processor in a memory device in communication with the processor, data related to the plan, the data including:
data relating to a savings account, including a date of establishment of the savings account;
an amount of the first target balance at the first target date at least 10 years after the establishment of the savings account; and
a term life insurance death benefit amount pursuant to a term life insurance policy issued at the time of establishment of the savings account and applicable to a death of the insured occurring after a deferral period of at least about three years; the death benefit amount for a date before the first target date being less than the first target balance and decreasing between an expiration of the deferral period and the first target date;
responsive to receiving by the processor data including a death of the insured, determining by the processor whether the death occurred during the deferral period and before the first target date;
responsive to the determining by the processor that the death occurred after the deferral period and before the target date, determining by the processor a benefit amount based on the date of death; and
providing by the processor an output signal indicative of an amount of payment, equal to the death benefit amount, to be made to the savings account.

16. The method of claim 15, wherein the determining the benefit amount includes accessing by the processor a database having savings plan data to obtain a balance of the savings account as of a selected date based on the date of death, and subtracting the obtained balance from the first target balance to obtain the benefit amount.

17. The method of claim 15, wherein the determining the benefit amount includes accessing by the processor from the memory device a benefit amount corresponding to the date of death.

18. The method of claim 15, wherein the received and stored data further comprises:
a second target balance at a second target date a period of years after the first target date for funding of a second expenditure;
a second term life insurance death benefit amount pursuant to the term life insurance policy; the second death benefit amount being for a date after the first target date and before the second target date, the second death benefit amount being less than the second target balance and decreasing between the first target date and the second target date;
and further comprising, responsive to receiving data indicative of a death of the insured and a date of death, determining by the processor if the date of death is after the first target date and before the second target date, and, responsive to determining by the processor that the date of death is after the first target date and before the second target date, determining by the processor a second death benefit amount based on the date of death; and
providing an output signal indicative of an amount of payment to be made to the savings plan, the amount equal to the second death benefit.

19. A computer-readable medium having a plurality of instructions thereon which, when executed by a processor, cause the processor to:
receive and store data related to a term life insurance and savings program, the data including:
identification of a savings account, including a date of establishment of the savings account;
an amount of a target balance at a target date at least 10 years after the date of establishment of the savings account; and
a term life insurance death benefit amount pursuant to a term life insurance policy issued at a time of commencement of the savings program and applicable to a death of the insured occurring after a deferral period of at least about three years; the death benefit amount for a date before the target date being less than the target balance and decreasing between an expiration of the deferral period and the first target date;
responsive to receiving data including a death of the insured, determining whether the death occurred during the deferral period and before the target date;
responsive to determining that the death occurred after the deferral period and before the target date, determining a benefit amount based on the date of death; and
provide an output signal indicative of an amount of payment to be made to the savings program, the amount being equal to the death benefit amount.

20. The computer-readable medium of claim 19, wherein the instructions further cause the processor to determine the benefit amount by accessing a balance of the savings program, and determine the death benefit by subtracting the from the target balance.

21. The computer-readable medium of claim 19, wherein the instructions further cause the processor to access from a memory device the death benefit amount based on a table mapping dates of death to death benefit amounts.

22. A computer system for determining terms of a long term savings program with deferred term life insurance, comprising:
a processor;
a memory device in communication with the processor;
the processor adapted to:
receive from a client device data including an age of a proposed insured, a nature of a proposed expense, data indicative of a date or range of dates at least 10 years in the future of the proposed expense, and data indicative of an amount of the proposed expense;
based on the received data, determine a plan including dates and amounts of periodic contributions to a savings account over a period of at least 10 years to the savings program; death benefit amounts for the deferred term life insurance; a deferral period of at least three years for the deferred term life insurance, and a premium for the deferred term life insurance; and
provide to the client device an output signal having data indicative of the plan;
wherein the premium is determined based on a unit cost of insurance determined based on a first discount factor based on the length of the deferral period, the probability of the insured surviving until the expiration of the deferral period, and the sum of the probabilities of death of the insured during each year following the expiration of the deferral period until the date of the last contribution, the probabilities of the death during each of the years being discounted by a discount factor specific to each of the years.

23. The system of claim 22, further comprising a printing and mailing system, wherein the processor is adapted to provide an output signal including data indicative of the plan to the printing and mailing system, and the printing and mailing system is adapted to print and mail an illustration including the data indicative of the plan.

24. The system of claim 22, wherein the premium amount for each year is determined based on a difference between a balance of the savings account and the target balance during the year.

25. A computer-implemented method for determining terms of a long term savings program with deferred term life insurance, comprising:
receiving by a processor from a client device data including an age of a proposed insured, a nature of a proposed expense, data indicative of a date or range of dates at least 10 years in the future of the proposed expense, and data indicative of an amount of the proposed expense;
based on the received data, determining by the processor a plan including dates and amounts of periodic contributions over a period of at least 10 years to the savings program; death benefit amounts for the deferred term life insurance; a deferral period of at least three years for the deferred term life insurance, and a premium for the deferred term life insurance; and
providing to the client device an output signal having data indicative of the plan;
wherein the premium is determined by the processor based on a unit cost of insurance determined based on a first discount factor based on the length of the deferral period, the probability of the proposed insured surviving until the expiration of the deferral period, and the sum of the probabilities of death of the proposed insured during each year following the expiration of the deferral period until the date of the last contribution, the probabilities of the death during each of the years being discounted by a discount factor specific to each of the years.

26. The method of claim 25, wherein the data indicative of the date of a proposed expense include a date of birth of a child and an indication that the savings plan is to fund a college education for the child.

27. The method of claim 25, wherein the probability of the proposed insured surviving and the probabilities of the death of the proposed insured are based on an age of the proposed insured and actuarial data accessed from a memory device.

28. A computer-readable medium having a plurality of instructions thereon which, when executed by a processor, cause the processor to:
receive from a client device data including an age of a proposed insured, a nature of a proposed expense, data indicative of a date or range of dates at least 10 years in the future of the proposed expense, and data indicative of an amount of the proposed expense;
based on the received data, determine a plan including dates and amounts of periodic contributions over a period of at least 10 years to the savings program; death benefit amounts for the deferred term life insurance; a deferral period of at least three years for the deferred term life insurance, and a premium for the deferred term life insurance; and
provide to the client device an output signal having data indicative of the plan;
wherein the premium is determined based on a unit cost of insurance determined based on a first discount factor based on the length of the deferral period, the probability of the insured surviving until the expiration of the deferral period, and the sum of the probabilities of death of the insured during each year following the expiration of the deferral period until the date of the last contribution, the probabilities of the death during each of the years being discounted by a discount factor specific to each of the years.

29. The computer-readable medium of claim 28, wherein the data indicative of the date of a proposed expense include a date of birth of a child and an indication that the savings plan is to fund a wedding for the child.

30. The computer-readable medium of claim 28, wherein the probability of the proposed insured surviving and the probabilities of the death of the proposed insured are based on an age and a gender of the proposed insured.
